(19) United States
(12) Patent Application Publication
(10) Pub. No.: US 2011/0167350 A1
(43) Pub. Date: Jul. 7, 2011

(54) Assist Features For Content Display Device

(75) Inventor: Quin C. Hoellwarth, Kuna, ID (US)

(73) Assignee: APPLE INC., Cupertino, CA (US)

(21) Appl. No.: 12/683,397

(22) Filed: Jan. 6, 2010

(51) Int. Cl. G06F 3/048; G06F 3/16; G06F 3/041

(52) U.S. Cl. 715/727; 715/863; 345/173

(57) ABSTRACT

Systems, techniques, and methods are present for allowing a user to interact with the text in a touch-sensitive display in order to learn more information about the content of the text. Some examples can include presenting augmented text from an electronic book in a user-interface, the user-interface displayed in a touch screen; receiving touch screen input by the touch screen, the touch screen input corresponding to a portion of the augmented text; determining a command associated with the touch screen input from amongst multiple commands associated with the portion of the augmented text, each of the multiple commands being configured to invoke a function to present information regarding the portion of the augmented text; and presenting, based on the command associated with the received touch screen input, information corresponding to the identified portion of the augmented text.

### TECHNICAL FIELD

This disclosure is related to displaying text in a touch screen user interface and associating one or more functions with portions of text.

### BACKGROUND

Many types of display devices can be used to display text. For example, text from electronic books (often called ebooks) can be stored on and read from a digital device such as an electronic book reader, personal digital assistant (PDA), mobile phone, a laptop computer or the like. An electronic book can be purchased from an online store on the world wide web and downloaded to such a device. The device can have buttons for scrolling through the pages of the electronic book as the user reads.

### SUMMARY

This document describes systems, methods, and techniques for interacting with text displayed on a touch screen, such as text in a electronic book (“ebook”). By interacting with the text, a user can obtain information related to the content of the text. For example, the text can be augmented with information not shown until a user interacts with a corresponding portion of the text, such as by using touch screen inputs in the form of gesture input or touch input.

A user can use various touch screen inputs to invoke functionality for a portion of the augmented text displayed on the touch screen. Various information can be presented regarding the content of the portion of the augmented text based on the type of touch screen input used to invoke functionality for the portion of the augmented text. For example, a first touch screen input can invoke a presentation of first information for the portion of the augmented text and a second touch screen input can invoke a presentation of second information for the portion of the augmented text. The presentation of information can include images, animations, interactive content, video content and so forth. Also, a touch screen input can invoke a presentation of audio content, such as an audible reading of the portion of the text.

In some examples, a touch screen input, such as pressing a portion of the display corresponding to a word, can invoke a presentation of media content regarding the word. Also, a touch screen input, such as pressing and holding a beginning word in a phrase and a last word in the phrase, can invoke the presentation of media content regarding the phrase.

If the portion of augmented text corresponding to a touch screen input includes a noun, media content can be presented that includes a still image that depicts the meaning of the noun. If the portion of augmented text includes a verb, an animation can be presented that depicts an action corresponding to the verb. Media content can also include interactive content such as a game, an interactive two- or three-dimensional illustration, a link to other content, etc.

In some examples, a touch screen input on a portion of the display corresponding to a portion of the augmented text can invoke a reading of the portion of augmented text. For example, when a user swipes a finger across a word, the swipe can produce a reading of the word as the finger passes across each letter of the word.

A method can include, providing text on a touch screen, the text including a plurality of text objects such as sentences or parts of a sentence; receiving touch screen input in a region corresponding to the one or more text objects; in response to touch screen input, presenting augmenting information about the one or more text objects and in accordance with received input. The touch screen input can include for example a finger swipe over the region corresponding to the text objects. The touch screen input can invoke an audible reading of the text objects. For example, the text objects can include a series of words. The touch screen input can be a swipe over the series of words. The words can be pronounced according to a speed of the swipe. The words can also be pronounced as the swipe is received.

The details of one or more embodiments are set forth in the accompanying drawings and the description below. Other features, objects, and advantages will be apparent from the description and drawings, and from the claims.

### DESCRIPTION OF DRAWINGS

FIG. 1 illustrates an example content display device.

FIG. 2 shows an example of a touch screen input interacting with a word.

FIGS. 3a-3c show an example of a touch screen input interacting with a word to invoke a presentation of audio and visual information.

FIGS. 4a-4e show an example of touch screen inputs interacting with a word.

FIGS. 5a-5d show an example of interacting with a word.

FIG. 6 shows an example of a touch screen input interacting with a word to invoke a presentation of an animation.

FIGS. 7a-7b show an example of touch screen inputs interacting with text.

FIG. 8 shows an example of a touch screen input interacting with a phrase.

FIG. 9 shows an example of a touch screen input interacting with a word to invoke a presentation of an interactive module.

FIGS. 10a-10b show an example of a touch screen inputs for invoking a presentation of foreign language information.

FIGS. 11a-11b show an example of a touch screen inputs for invoking a presentation of foreign language information.

FIG. 12 shows an example process for displaying augmented information regarding a portion of text.

FIG. 13 shows an example process for displaying information regarding augmented text based on a touch screen input type.

FIG. 14 is a block diagram of an example architecture for a device.

FIG. 15 is a block diagram of an example network operating environment for a device.

Like reference symbols in the various drawings indicate like elements.

### DETAILED DESCRIPTION

### Example Device

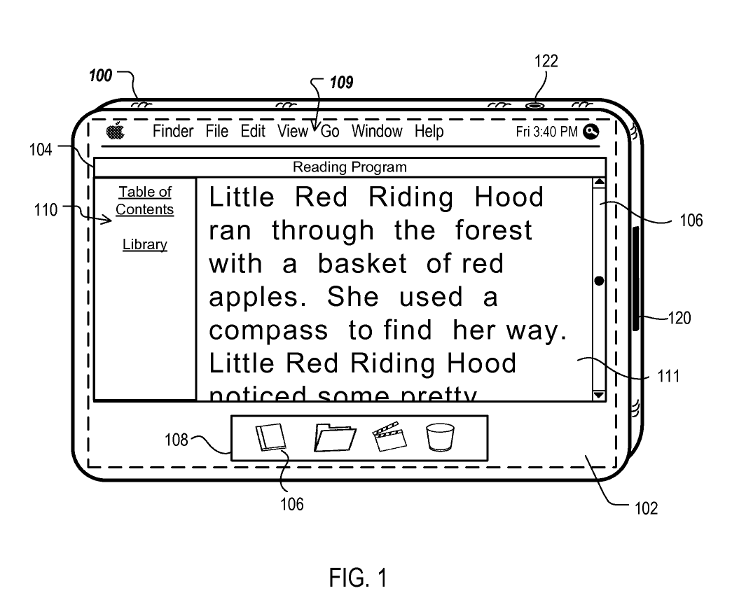

FIG. 1 illustrates example content display device 100. Content display device 100 can be, for example, a laptop computer, a desktop computer, a tablet computer, a handheld computer, a personal digital assistant, an ebook reader, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Device Overview

In some implementations, content display device 100 includes touch-sensitive display 102. Touch-sensitive display 102 can implement liquid crystal display (LCD) technology, light emitting polymer display (LPD) technology, electronic ink display, OLED or some other display technology. Touch-sensitive display 102 can be sensitive to haptic and/or tactile contact with a user. In some implementations, touch-sensitive display 102 is also sensitive to inputs received in proximity to, but not actually touching, display 102. In addition, content display device 100 can also include a touch-sensitive surface (e.g., a trackpad or touchpad).

In some implementations, touch-sensitive display 102 can include a multi-touch-sensitive display. A multi-touch-sensitive display can, for example, process multiple simultaneous points of input, including processing data related to the pressure, degree, and/or position of each point of input. Such processing facilitates gestures and interactions with multiple fingers, chording, and other interactions. Other touch-sensitive display technologies can also be used, e.g., a display in which contact is made using a stylus or other pointing device.

A user can interact with content display device 100 using various touch screen inputs. Example touch screen inputs include touch inputs and gesture inputs. A touch input is an input where a user holds his or her finger (or other input tool) at a particular location. A gesture input is an input where a user moves his or her finger (or other input tool). An example gesture input is a swipe input, where a user swipes his or her finger (or other input tool) across the screen of touch-sensitive display 102. In some implementations, content display device 100 can detect inputs that are received in direct contact with touch-sensitive display 102, or that are received within a particular vertical distance of touch-sensitive display 102 (e.g., within one or two inches of touch-sensitive display 102). Users can simultaneously provide input at multiple locations on touch-sensitive display 102. For example, inputs simultaneously touching at two or more locations can be received.

In some implementations, content display device 100 can display one or more graphical user interfaces on touch-sensitive display 102 for providing the user access to various system objects and for conveying information to the user. In some implementations, a graphical user interface can include one or more display objects, e.g., display objects 104 and 106. In the example shown, display objects 104 and 106, are graphic representations of system objects. Some examples of system objects include device functions, applications, windows, files, alerts, events, or other identifiable system objects. In some implementations, the display objects can be configured by a user, e.g., a user may specify which display objects are displayed, and/or may download additional applications or other software that provides other functionalities and corresponding display objects.

### Example Device Functionality

In some implementations, content display device 100 can implement various device functionalities. As part of one or more of these functionalities, content display device 100 presents graphical user interfaces on touch-sensitive display 102 of the device, and also responds to input received from a user, for example, through touch-sensitive display 102. For example, a user can invoke various functionality by launching one or more programs on content display device 100. A user can invoke functionality, for example, by touching one of the display objects in menu bar 108 of content display device 100. For example, touching display object 106 invokes an electronic book application on the device for accessing a stored electronic book (“ebook”). A user can alternatively invoke particular functionality in other ways including, for example, using one of user-selectable menus 109 included in the user interface.

Once a program has been selected, one or more windows corresponding to the program can be displayed on touch-sensitive display 102 of content display device 100. A user can navigate through the windows by touching appropriate places on touch-sensitive display 102. For example, window 104 corresponds to a reading application for displaying an ebook. Text from the ebook is displayed in pane 111. In the examples shown in FIGS. 1-11b, the text is from a children's book.

The user can interact with window 104 using touch input. For example, the user can navigate through various folders in the reading application by touching one of folders 110 listed in the window. Also, a user can scroll through the text displayed in pane 111 by interacting with scroll bar 112 in window 104. Also, touch input on the display 102, such as a vertical swipe, can invoke a command to scroll through the text. Also, touch input such as a horizontal swipe can flip to the next page in a book.

In some examples, the device can present audio content. The audio content can be played using speaker 120 in content display device 100. Audio output port 122 also can be provided for connecting content display device 100 to an audio apparatus such as a set of headphones or a speaker.

In some examples, a user can interact with the text in touch-sensitive display 102 while reading in order to learn more information about the content of the text. In this regard, the text in an ebook can be augmented with additional information (i.e. augmenting information) regarding the content of the text. Augmenting information can include, for example, metadata in the form of audio and/or visual content. A portion of the text, such as a word or a phrase, can be augmented with multiple types of information. This can be helpful, for example, for someone learning how to read or how to learn a new language.

As a user reads, the user can interact with the augmented portion of the text using touch screen inputs via touch-sensitive display 102 to invoke the presentation of multiple types of information. The content of a portion of text can include an image of the text, the meaning of the portion of the text, grammatical information about the portion of text, source or history information about the portion of the text, spelling of the portion of the text, pronunciation information for the portion of text, etc.

When interacting with text, a touch screen input can be used to invoke a function for a particular portion of text based on the type of touch screen input and a proximity of the touch screen input to the particular portion of text. Different touch screen inputs can be used for the same portion of text (e.g. a word or phrase), but based on the touch screen input type, each different touch screen input can invoke for display different augmenting information regarding the portion of the text.

The following are some of the various examples of touch screen inputs that can invoke a command to present augmenting information for a portion of text. For example, a finger pressing on a word in the text can invoke a function for the word being pressed. A finger swipe can also invoke a function for the word or words over which the swipe passes. Simultaneously pressing a first word in a phrase (i.e. a series of words) and a second word in the phrase can invoke functionality for all of the words between the first word and the second word. Alternatively, simultaneously pressing a first word in a phrase (i.e. a series of words) and a second word in the phrase can invoke functionality for just those words. Also, simultaneously pressing on a word or word(s) with one finger and swiping with another finger can invoke functionally for the word or word(s). Double tapping with one finger and swiping on the second tap can invoke functionality for the words swiped.

In some examples, a swipe-up from a word can invoke a presentation of first augmenting information such as an image; a swipe down from a word can invoke a presentation second information, such as an audible presentation of a definition of the word based on the context of the word; a swipe forward can invoke a presentation of third augmenting information for the word such as an audible pronunciation of the word; and a swipe backward can invoke a presentation of fourth augmenting information such as a presentation of a synonym. Each type of swipe can be associated with a type of augmenting information in the preference settings.

In some examples, a touch screen input can be combined with another type of input such as audio input to invoke a command to present information regarding augmenting text. For example, a swipe can be combined with audible input in the form of a user reading the swiped word into device 100. This combination of touch-screen input and audio input can invoke a command in device 100 to determine whether the pronunciation of the swiped word is accurate. If so, device 100 can provide audio and/or visual augmenting information indicating as much. If not, device 100 can present audio and/or visual augmenting information such as to indicate that the swiped word was improperly pronounced. This can be helpful, for example, for someone learning how to read or how to learn a new language.

In some implementations, a user can set preferences in an e-book indicating what commands are invoked by what touch inputs. A type of touch screen input can invoke the presentation of the same type of information for all augmented text in a particular text such as an e-book. In some examples, a user can set a single-finger input to invoke no command so that a user can read the e-book using his/her finger without invoking a command to present information (or alternatively a single finger can be used for paging, scrolling). At the same time, another touch screen input can be set to invoke a command to present information about a portion of the text such as a double-finger input. Of course, the opposite implementation may be performed. That is, a single input may be used to invoke a command while a double finger input may be disregarded or used for paging or scrolling. Any number of fingers may be used for different sets of preferences.

Preferences can change depending on the type of e-book. In one embodiment, a first set of preferences are used for a first type of books while a second set of preferences are used for a second type of book. For example, a single finger swipe for children's books can invoke a command to present image and/or audible information whereas for adult books a single finger swipe can invoke no command to present information or alternatively be used for paging or scrolling. A different command such as a double-finger swipe in adult books can be set to invoke a command to present image and/or audible information.

In some examples, a finger swipe over a series of words can invoke no command until the finger swipe stops. Information can be presented regarding the word over which the finger stops. When the finger continues to swipe again the presented information can be discontinued.

In some examples, preferences can be set such that a particular touch screen input can invoke a command to present a visual image of a word or words corresponding to the touch input for children's books whereas the same touch input can invoke a command in adult books to present a definition of the word or words corresponding to the touch input.

In some examples, when presenting a definition and/or an image corresponding to a word, the definition and/or image can be based on the words context. For example, a particular word can have multiple definitions. Based on the context of the word, e.g., the context in the sentence and/or paragraph, the definition and/or image can be the definition and/or image corresponding the identified definition based on the context.

In some examples, a touch screen input can alter the display of the words corresponding to that input. For example, as a user reads an e-book, the user can move his/her finger left to right over words as her or she reads. As the user swipes in this manner, the words can change relative to the text that has not been swiped. The swiped words can change to a different size, different color, italics, etc.

Also, a touch screen input can be on a region corresponding to the word or word(s). For example, a corresponding region can be offset from a word such as below the word so that a user can invoke a command for the word without covering up the word. Preferences can also be set so that visual information displayed in response to a touch input is always displayed offset from the corresponding word or words, such as above the word or words, so that continuous reading is not impeded.

Augmenting information for text of an ebook can be included as part of a file for the ebook. In some examples, augmenting information for ebook text can be loaded onto the content display device 100 as a separate file. Also, an application on the content display device 100 or provided by a service over a network can review text on the content display device 100 and determine augmenting information for the text. When a user loads an ebook, the user can prompt such a service to augment the text in the book according to preferences set by the user. The augmenting information can be loaded into storage on content display device 100 and can be presented when a user interacts with the augmented text. The augmenting information can include a listing of touch screen input types that correspond to the augmenting information. In some examples, when a user interacts with text using a touch screen input, the touch screen inputs can invoke a command that directs the content display device 100 to obtain information for display over a network.

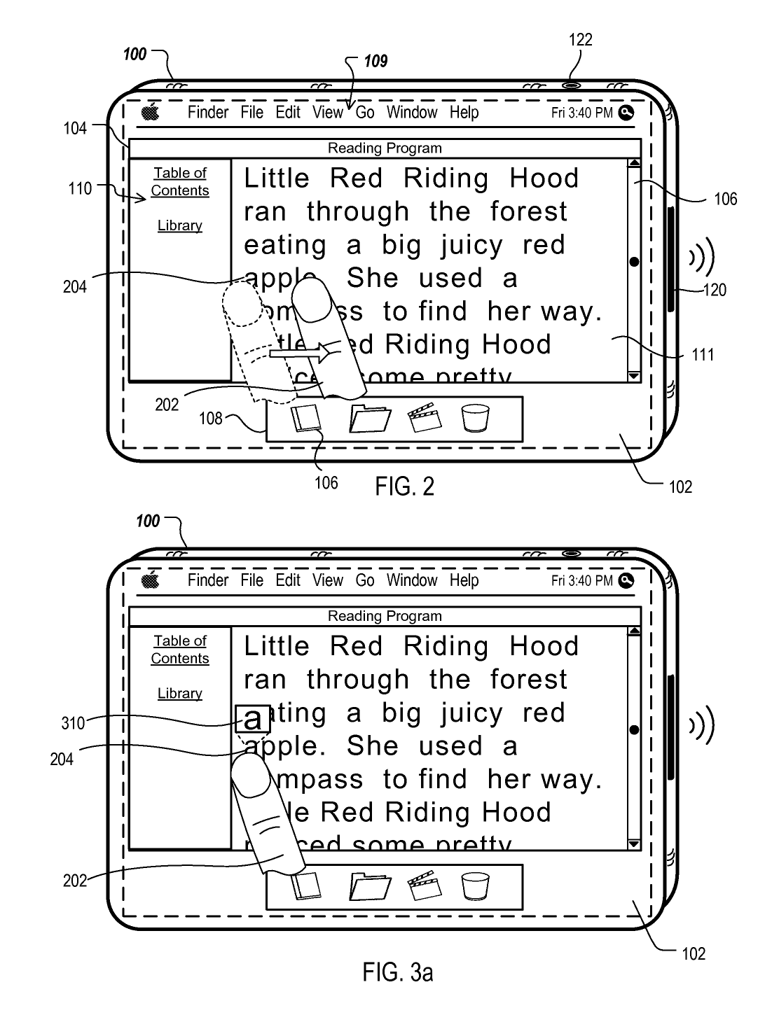

The following examples, corresponding to FIGS. 2-11b, discuss interacting with portions of text using various touch screen inputs. The examples of touch screen inputs described are not meant to be limiting. A plurality of functions can be associated with the text and each function can be invoke by a corresponding touch screen input. For example, any touch screen input can be assigned to a function, so long as it is distinguishable from other touch screen inputs and is consistently used. For example, either a tap input, a press-and-hold input, or a press-and-slide input can be assigned to a particular function, so long as the input is assigned consistently. Example touch screen input types can include but are not limited to: swipe, press-and-hold, tap, double-tap, flick, pinch, multiple finger tap, multiple finger press-and-hold, press-and-slide.

FIG. 2 shows an example of a touch screen input interacting with word 204. Word 204 is the word “apple.” The touch screen input is a gesture input in the form of a swipe with finger 202 from left to right over word 204, starting from the first letter, the letter “a,” to the last letter, the letter “e”. The gesture input invokes functionality for word 204 because the gesture input swipes over a region corresponding to word 204, indicating that the gesture input is linked to word 204.

The gesture input invokes a command to present information about word 204 in the form of an audible reading of word 204 (i.e. “apple”). In some implementations, word 204 can be read at a speed proportional to the speed of the gesture input. In other words, the faster the swipe over word 204, the faster word 204 is read. Also, the slower the swipe over word 204, the slower word 204 is read (e.g. sounded out). Word 204 can also be read as the gesture input is received. For example, when the finger is over the letter “a” in the word “apple” an a-sound is pronounced; as the finger swipes over the “pp”, a p-sound is pronounced; and as the finger swipes over the “le”, an l-sound is pronounced.

A touch screen input can also identify multiple words, such as when the swipe passes over a complete phrase. In such an example, the phrase can be read at a rate independent of the touch screen input or as the touch screen input is received according to a speed of the touch screen input. Also, a touch screen input can invoke a command for a complete sentence. For example, a swipe across a complete sentence can invoke a command to read the complete sentence (i.e., “Little Red Riding Hood ran through the forest eating a big juicy red apple.”).

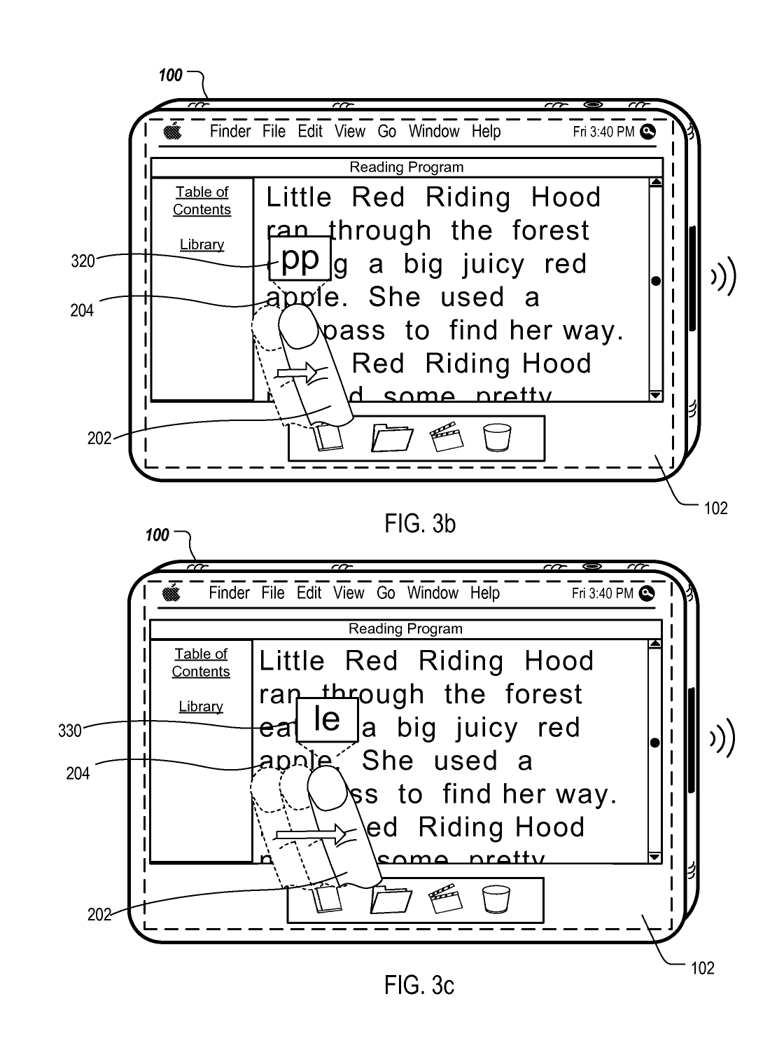

FIGS. 3a-3c show an example of a touch screen input interacting with word 204 to invoke the presentation of audio and visual information about word 204. The touch screen input in FIGS. 3a-3c is a gesture input in the form of a swipe with finger 202 over word 204, starting from the first letter in and ending with the last letter in word 204. As finger 202 passes over each letter of the word, the word is read. Word 204 can be read in phonetic segments according to how the word is normally pronounced. Also, the letters corresponding to each of the phonetic segments of word 204 are shown in an overlay as each of the respective phonetic segments is pronounced. For example, as finger 202 swipes over the first letter (FIG. 3a) of word 204, overlaid letter 310 of the letter “a” is displayed as the sound corresponding to the letter “a” is read. As the swipe moves over the “pp” portion of the word 204 (FIG. 3b), a long p-sound is read and an overlay of “pp” is shown at 320. As the swipe continues over the “le” portion of the word (FIG. 3c), an overlaid “le” is shown at 330 as an l-sound is read.

In some implementations, the letters corresponding to the phonetic segment being pronounced can be magnified, highlighted, offset etc. as the swipe is received. For example, as shown, the phonetic segment may be magnified and offset above the word. Alternatively or additionally, portions of the word itself may be modified. The swipe can also be backwards and the phonetic segments can be presented in reverse order as described above.

It should be appreciated that presenting both sets of information is an embodiment and not a limitation. In some circumstances, only one set of information is delivered. For example, the visual information may be presented with audio information.

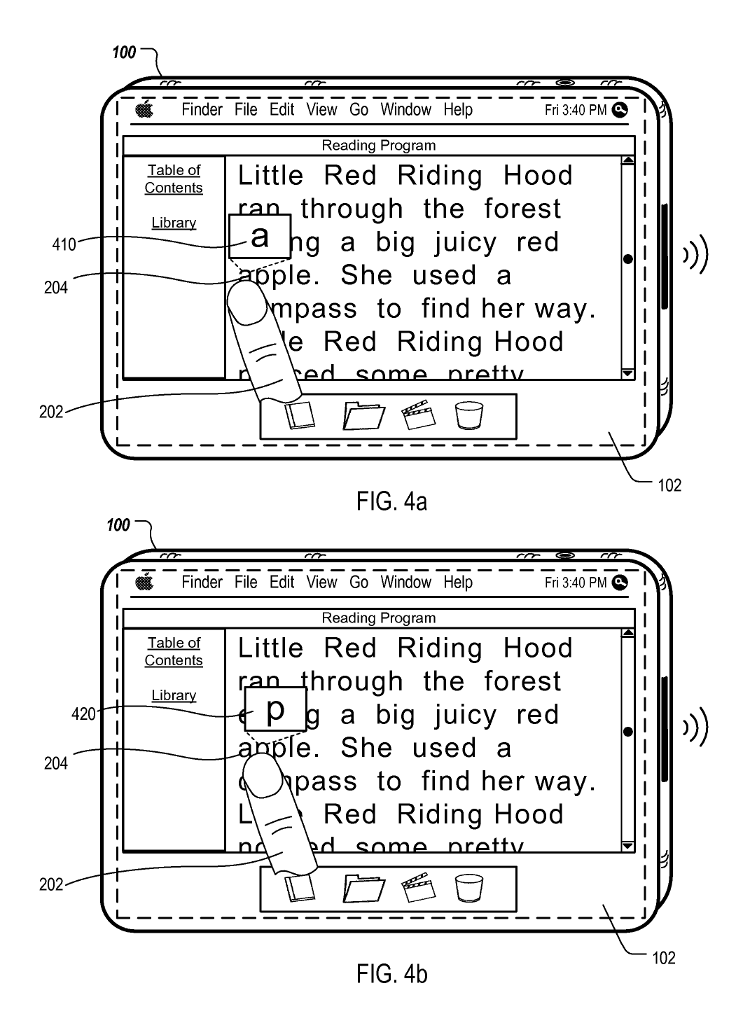

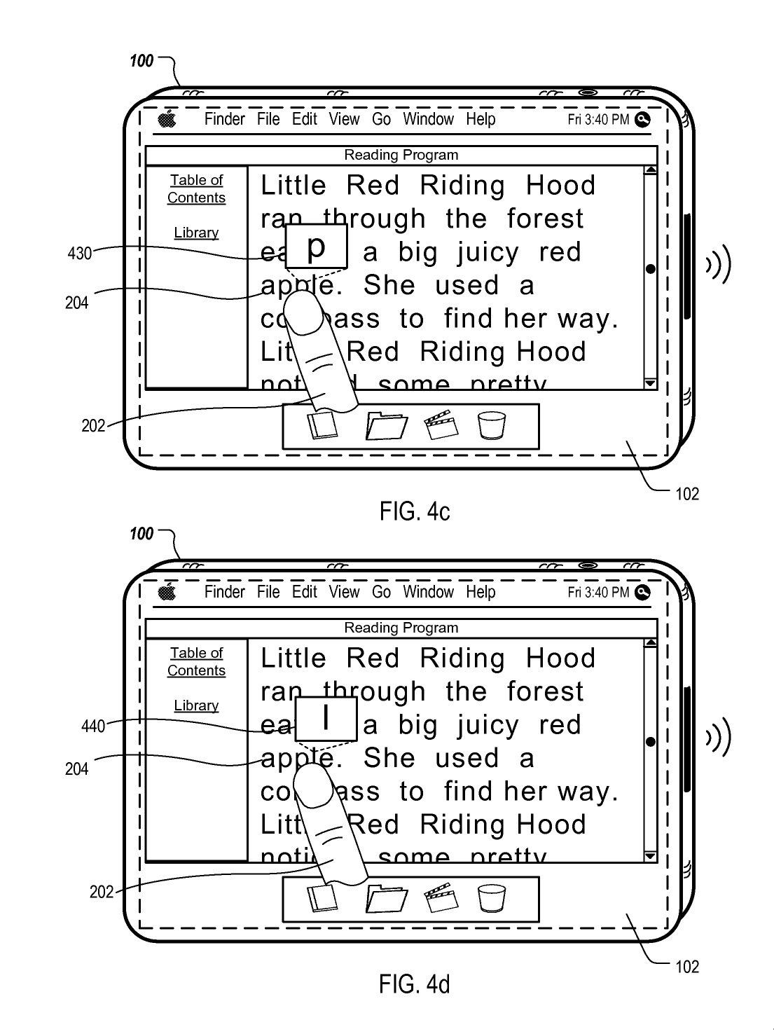

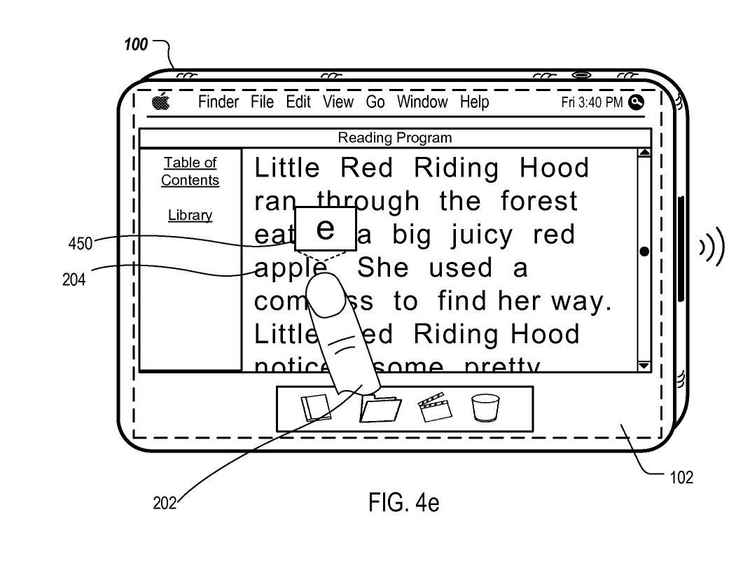

FIGS. 4a-4e show an example of touch screen inputs interacting with word 204. Each of the touch screen inputs in FIGS. 4a-4e is a tap, i.e. a pressing and removing of the finger, over the different letters of word 204, which produces an alphabetical reading of the letter being pressed i.e. an audible presentation of the letter name (e.g. “/a/, /p/, /p/, /l/, /e/”). For example, when the first letter of word 204, the letter “a”, is tapped, the first letter is presented in an overlay and is read as it is pronounced in the alphabet. As each letter is tapped in word 204 as shown in FIGS. 4b-4e, respective letters 410, 420, 430, 440, and 450 are presented in an overlay and an audible alphabetical pronunciation of the letter name is presented. In this manner, word 204 can be audibly spelled-out using the letter names rather than sounded out. Instead of an overlay, the letters themselves can be visually altered such as magnified, offset, changed different color, highlighted etc. In some cases, a swipe over the word may be used in lieu of or in addition to individual taps. That is, as the finger is swiped, the audible and visual information is presented based on the location of the finger relative to letters in the word.

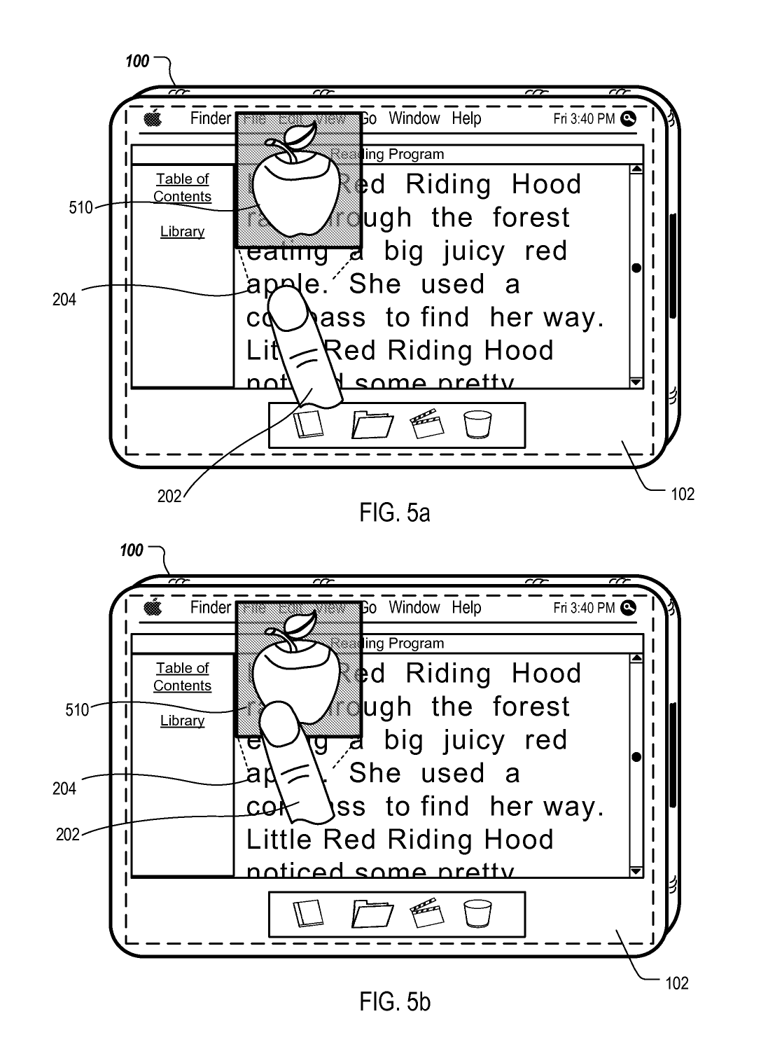

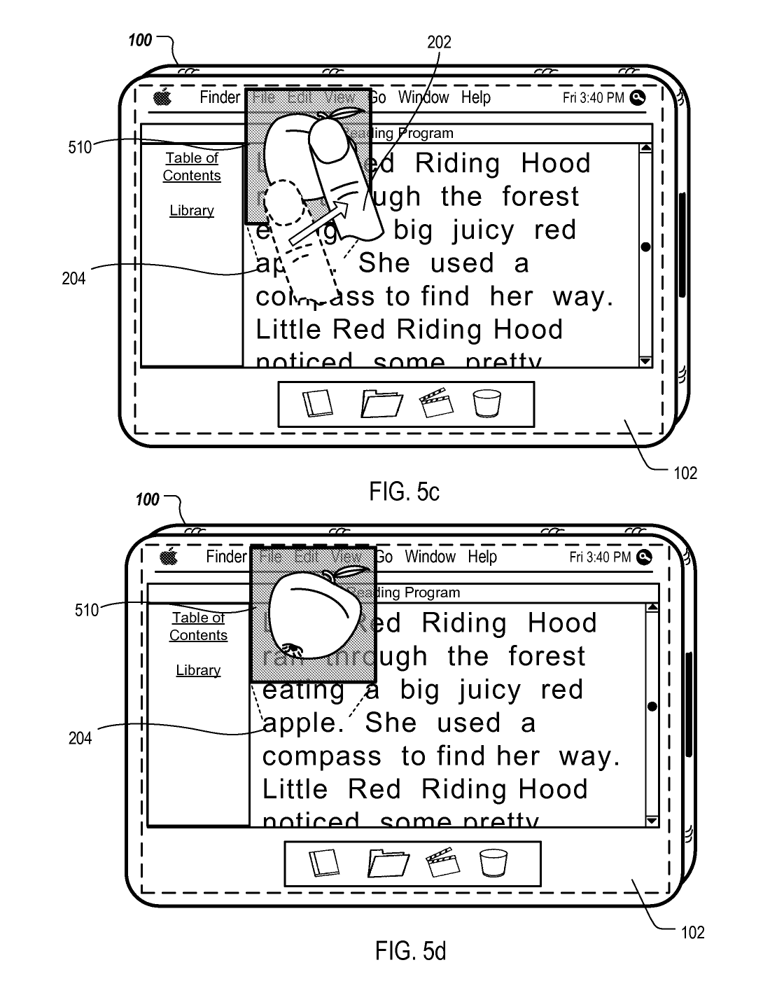

FIGS. 5a-5d show an example of interacting with word 204. The touch screen input shown in FIG. 5 is a press-and-hold on word 204, the word “apple”. When finger 202 is pressed and held on word 204 for a predetermined time period, a command is invoked to display an image corresponding to the meaning of the word “apple.” Other touch screen inputs can also be assigned to invoke a command to display an image such as a swipe, tap, press-and-slide etc. In this example, illustration 510 of an apple is displayed superimposed over the text above word 204. In some examples, illustration 510 can be displayed only as long as the finger is pressed on word 204. In other examples, the illustration can be displayed for a predetermined time period even if the finger is removed.

In some examples, illustration 510 can be interactive. For example, the apple can be a three-dimensional illustration that can be manipulated to show different views of illustration 510. FIGS. 5b-5d show finger 202 removed from word 204 and interacting with illustration 510. In FIG. 5b, finger 202 is pressed on the bottom left corner of the apple. FIG. 5c shows the finger swiping upwards and to the right. This gesture input roles the apple as shown in FIG. 5d. Also, the user can zoom-in and/or out on the apple using gestures such as pulling two fingers apart or pinching two fingers together on a region corresponding to the apple.

Touch screen inputs can also be received, such as touch screen inputs on illustration 510, that invoke a command to present other information regarding the word apple. For example, a touch screen input such as a press-and-hold on illustration 510 can invoke a command to display information about word 204 such as a written definition. The information can be presented based on the context of word 204. Illustration 510 can change size and/or location to provide for the presentation of the additional information. Additional information can include, for example, displaying the illustration 510 with the text of an apple being wrapped around the apple.

Also, illustration 510 is displayed as an overlaid window. In some examples, illustration can be just the image corresponding to word 204. The image can also replace word 204 for a temporary period of time. In some examples, the line spacing can be adjusted to compensate for the size of the image. In some examples a touch screen input can cause the image to replace word 204, and the same or another touch screen input can cause the image to change back into word 204. In this manner, a user can toggle between the image and word 204. In some examples, the illustration may even replace the word at all instances of the word on the page or in the document.

The display of illustration 510 can remain until a predetermined time-period expires or a touch screen input is received to remove (e.g. close) the display of illustration 510. Also, shaking one or more inputs can invoke a command to remove the image from touch-sensitive display 102, such as shaking content display device 100.

In some cases, the user may swipe their finger across a phrase (group of words) such that at least a portion of the phrase may be read with images rather than text. Each word changes between text and image as the finger is swiped proximate the word. For example, if the first sentence in FIG. 5 is swiped, some or all the words may be replaced with images. In one example, only the major words are changed (nouns, verbs, etc.) as the finger is swiped.

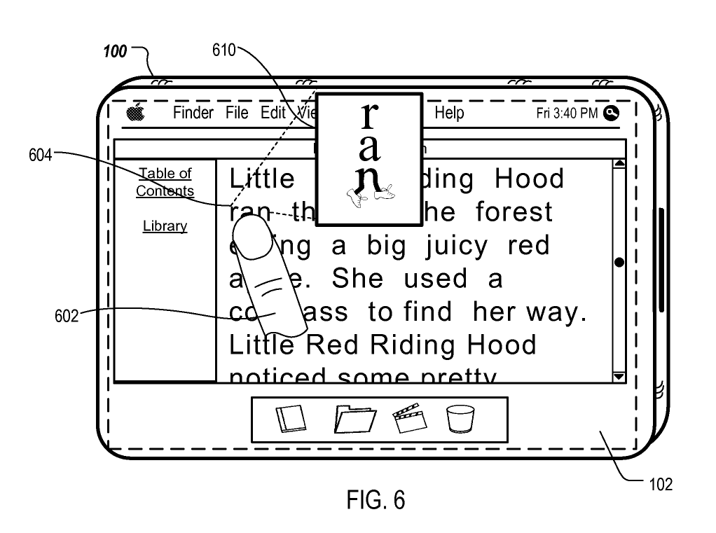

FIG. 6 shows an example of a touch screen input interacting with word 604 to invoke a presentation an animation. The touch screen input shown in FIG. 6 is a press-and-hold on word 604, the word “ran”. (Other touch screen inputs can be used such as a discrete swipe beginning with the first letter and ending with the last letter). When finger 602 presses and holds on word 604 for a preset time period, a command is invoked to display illustration 610 corresponding to the meaning of word 604. In the example shown, the illustration 610 shows an animated form of the word “ran” running. In some examples, an animation of a runner running can be shown. In some examples, actual word 604 can change from a fixed image into an animation that runs across touch-sensitive display 102. In some examples, video content can be displayed to depict the action of running.

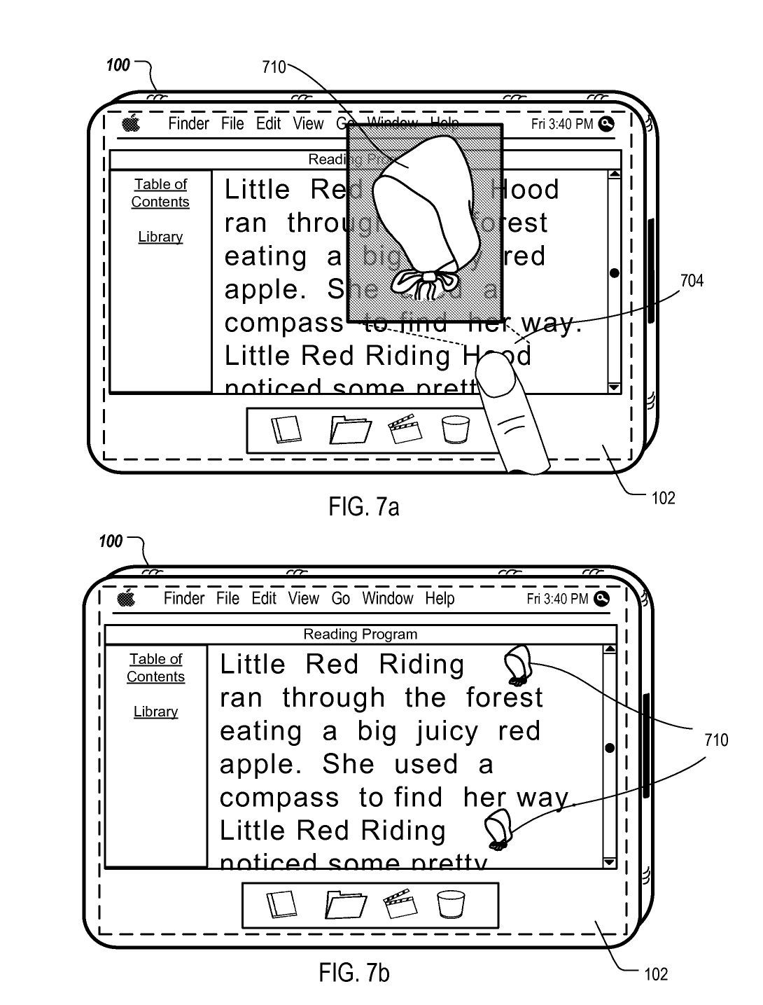

FIGS. 7a-7b show an example of touch screen inputs interacting with text to invoke a presentation of image 710. In FIG. 7a, the touch screen input is a press-and-hold on word 704, the word “hood”. The touch screen input invokes a command to display image 710 of a hood. In FIG. 7b, another touch screen input invokes a command to cause the image to replace each instance of the word “Hood” with an instance of image 710.

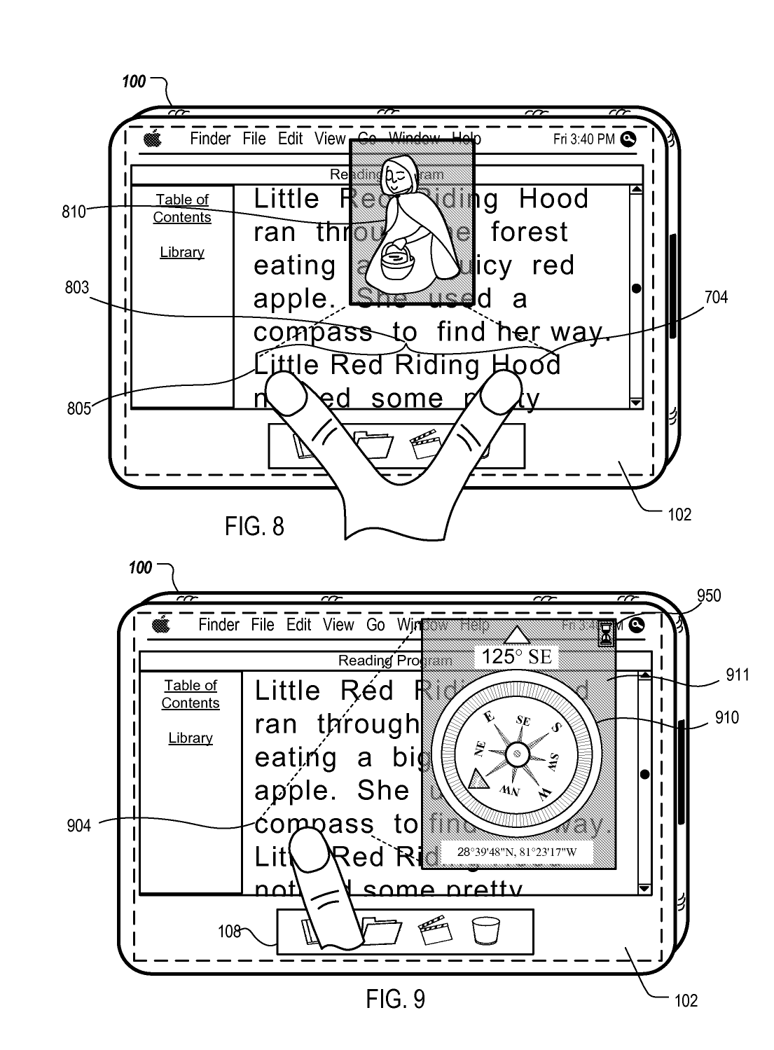

FIG. 8 shows an example of a touch screen input interacting with phrase 803. The touch screen input is a press-and-hold using two fingers instead of one, a first finger pressing first word 805, the word “Little”, and a second finger concurrently pressing a second word, the word 704 (“Hood”). The touch screen input invokes functionality corresponding to phrase 804, “Little Red Riding Hood,” which begins with first word 805 and ends with second word 704. The touch screen input invokes a command to display information regarding phrase 803 superimposed over the text. The information, in the example shown, is illustration 810 of a Little Red Riding Hood, the character in the story of the ebook being displayed.

FIG. 9 shows an example of a touch screen input interacting with word 904 to invoke a presentation of an interactive module. The touch screen input is a press-and-hold using one finger on word 904, the word “compass.” The touch screen input invokes a command to display interactive module 910 superimposed over the text of the ebook. In the example shown, interactive module 910 includes interactive compass 911. Compass 911 can be a digital compass built-in to content display device 100 that acts like a magnetic compass using hardware in the content display device 100 to let the user know which way he or she is facing.

Interactive module 910 can be shown only for a predetermined time period as indicated by timer 950. After the time expires, the interactive module 910 is removed showing the text from the ebook. In some examples, a second touch screen input can be received to indicate that module 910 is to be removed, such as a flick of the module off of touch-sensitive display 102. In some examples, shaking content display device 100 can invoke a command to remove interactive module 910.

An interactive module can include various applications and/or widgets. An interactive module can include for example a game related to the meaning of the word invoked by the touch screen input. For example, if the word invoked by the touch screen input is “soccer”, a module with a soccer game can be displayed. In some examples, an interactive module can include only a sample of a more complete application or widget. A user can use a second touch screen input to invoke a command to show more information regarding the interactive module, such as providing links where a complete version of the interactive module can be purchased. In some examples, if the word invoked by the touch screen input is a company name, e.g. Apple Inc., a stock widget can be displayed showing the stock for the company. If the word invoked by the touch screen input is the word “weather” a weather widget can be presented that shows the weather for a preset location or for a location based on GPS coordinates for the display device. If the word invoked by the touch screen input is the word “song”, a song can play in a music application. If the word invoked by the touch screen input is the word “add”, “subtract,” “multiply,” “divide” etc. a calculator application can be displayed.

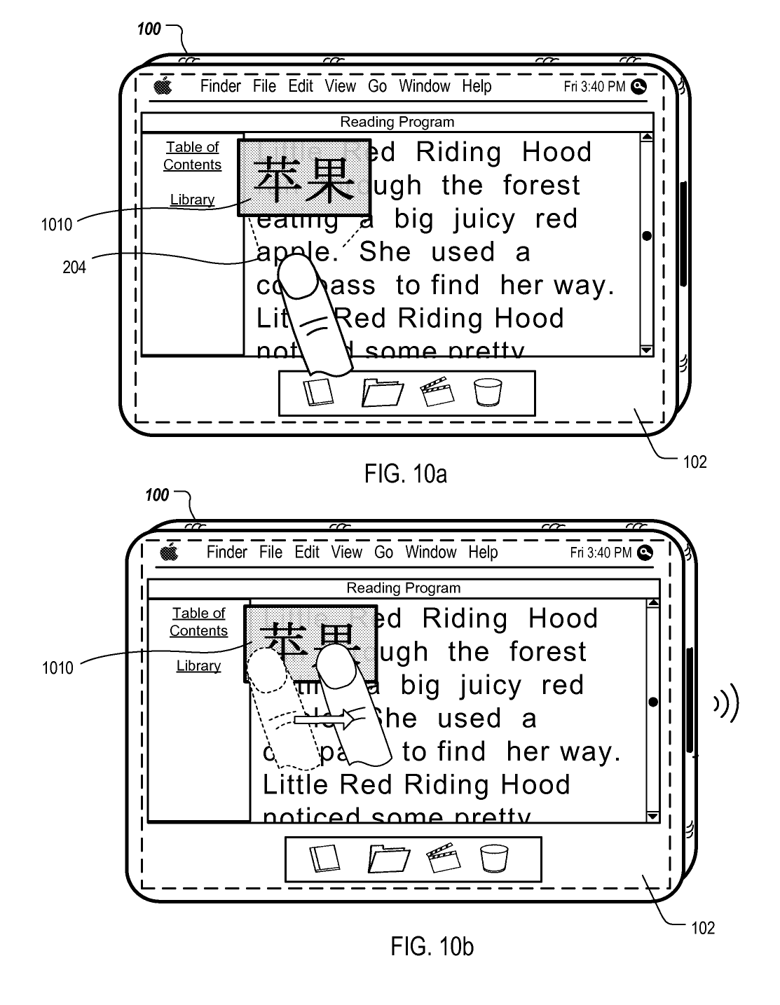

FIGS. 10a-10b show an example of touch screen inputs for invoking presentation of foreign language information. Word 204 is the word “apple.” The touch screen input can be a press and hold with a finger on word 204. The touch screen input invokes a command to display foreign language information regarding the word. In the example shown, Chinese characters 1010 for word 204 (“apple”) are shown superimposed over the text.

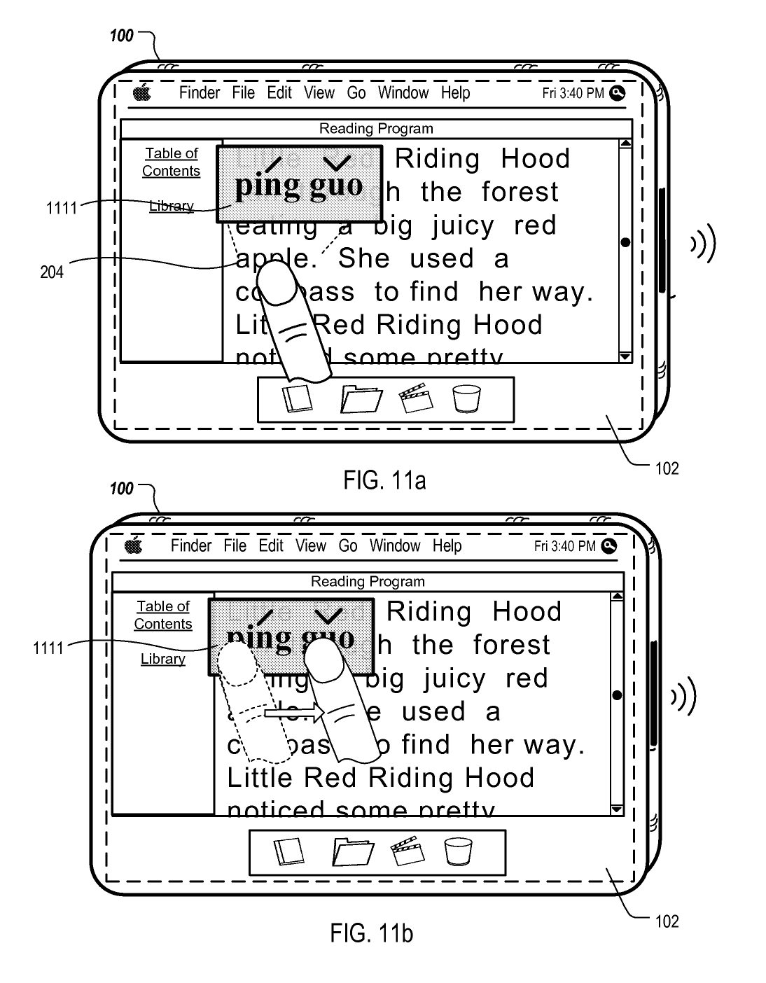

A different touch screen input, such as a tap, can be used to invoke a command to display different information regarding word 204. For example, in FIG. 11a, the finger taps word 204 instead of pressing-and-holding. In this example, pronunciation in pinyin 1111 for the Chinese word 204 is displayed superimposed over the text, and the word “apple” in Chinese is audibly read. In some examples, a swipe over the word apple can produce an audible reading of the word in a foreign language, the reading produced at a speed corresponding to the speed of the swipe.

The display of foreign language information can also be interactive. For example, Chinese characters 1010 shown in FIG. 10b can be interactive. A touch screen input, in the form of a swipe over the characters as they are displayed invokes a command to read word 204 in Chinese that correspond to those characters. Also, as shown in FIG. 11b, a swipe over the pinyin 1111 can invoke a command to read the Chinese word corresponding to pinyin 1111 at a speed corresponding to a speed of the swipe.

In some examples, a user can preset language preferences to choose a language for augmenting the text of the ebook. As the user reads, the user can interact with the text to learn information regarding the content of the text in the selected foreign language.

Other information can be used to augment text of an ebook such as dictionary definitions, grammatical explanations for the text, parts of speech identifiers, pronunciation (e.g. a visual presentation of “[ap-uhl]”) etc. The information can be presented in various forms such as text information, illustrations, images, video content, TV content, songs, movie content, interactive modules etc. Various touch screen inputs can be used to invoke functionality for a portion of text and each touch screen input type can invoke a different command to present different information about the portion of text.

In some examples, portions of text that are augmented can be delineated in such a way that the user can easily determine whether the text has augmenting information that can be invoked with a touch screen input. For example, a portion of text that has augmenting information can be highlighted, underlined, displayed in a different color, flagged with a symbol such as a dot etc. The same touch screen input type for different portions of text can invoke the presentation of the same type of information. For example, a swipe over a first portion of text can invoke a presentation of a reading of the first portion of text, and a swipe over second portion of text can also invoke a presentation of a reading of the second portion of text.

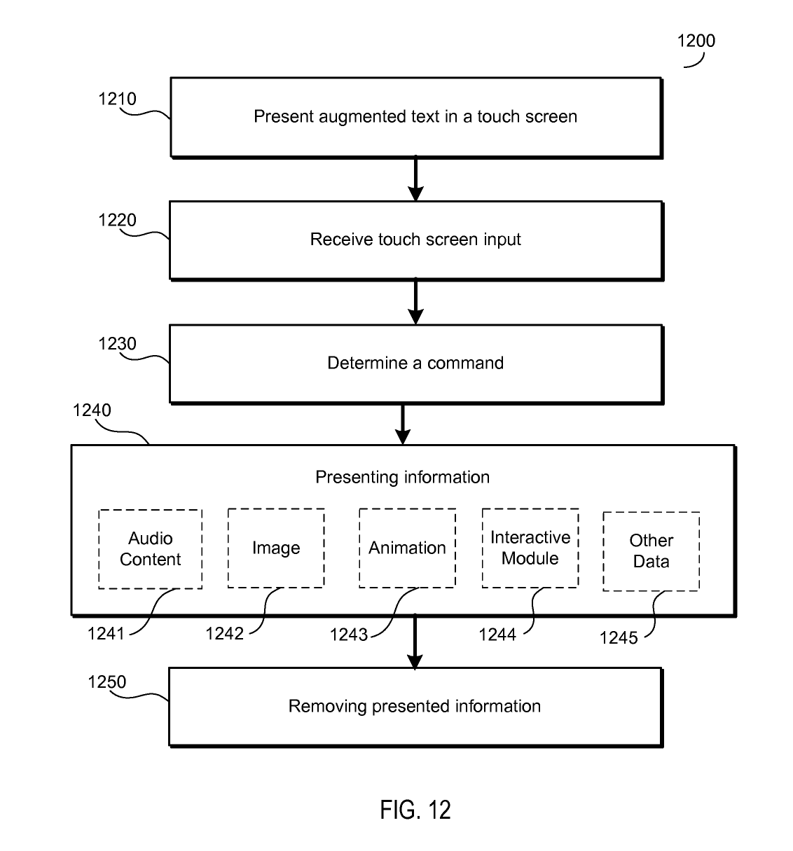

FIG. 12 shows example process 1200 for displaying augmenting information regarding a portion of text. At 1210, augmented text, such as text from an electronic book is presented in a touch screen. The text can be displayed in a user-interface such as an ebook reading application. At 1220, touch screen input is received, such as a touch input or a gesture input. The touch screen input corresponds to a portion of the augmented text. For example, the touch screen input can correspond to a portion of the text based on the proximity of the touch screen input to the portion of the text. Various types of touch screen inputs can correspond to the same portion of the text.

At 1230, a command associated with the touch screen input for the portion of text is determined. The command can be determined from amongst multiple commands associated with the portion of the text. Each touch screen input corresponding to the portion of the text can have a different command for invoking for display different information regarding the content of the portion of the text. At 1240, information is presented based on the command associated with the touch screen input. The information presented corresponds to the portion of text. For example, the presented information can be audio content 1241, an image 1242, animation 1243, interactive module 1244, and/or other data 1245. The presented information can be displayed superimposed over the text. Also, at 1250 the presented information optionally can be removed from the display. For example, the presented information can be removed after a predetermined time period. Also, an additional input can be received for removing the presented information.

Presenting audio content 1241 can include an audible reading of the portion of text, such as a word or series of words. For example, when a user swipes a finger over the portion of the text, the portion of the text can be read. The speed of the swipe can dictate the speed of the reading of the portion of the text such that the slower the speed of the swipe, the slower the reading of the portion of the text. Also, a reading of a word can track the swipe such that an audible pronunciation of a sound for each letter of the word can be presented as the swipe passes over each respective letter of the word.

Presenting image 1242 can include presenting an illustration related to the meaning of the portion of the text. For example, if the portion of the text includes a noun, the illustration can include an illustration of the noun. If the portion of the text includes a verb, animation 1243 can be presented, performing the verb. In some examples, the animation can be the identified portion of the text performing the verb.

Presenting interactive module 1244 can include presenting a game, an interactive 3-dimensional illustration, an application and/or a widget. A user can interact with the interactive module using additional touch screen inputs.

Presenting other data 1245 can include presenting other data regarding the content of the portion of text. For example, foreign language information, such as translation and/or pronunciation information for the portion of the text can be presented. Also, definitions, grammatical data, context information, source information, historical information, pronunciation, synonyms, anonyms, etc. can be displayed for the portion of the text.

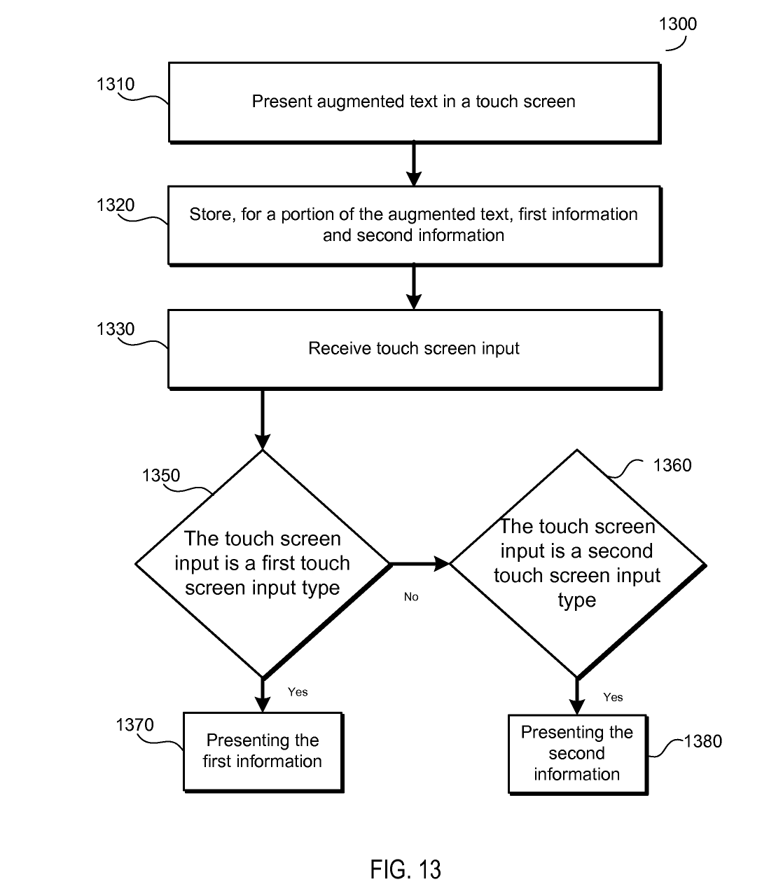

FIG. 13 shows example process 1300 for displaying information regarding augmented text based on a touch screen input type. At 1310, augmented text is presented in a touch screen. The augmented text can be presented in a user-interface such as an ebook reader application. A portion of text can have multiple corresponding touch screen inputs, each touch screen input corresponding to different information. For example, at 1320, first information and second information is stored for a portion of the augmented text. The first information corresponds to a first touch screen input type. The second information corresponds to a second touch screen input type. Also, the first information and the second information relate to content associated with the portion of the augmented text.

At 1330, user input is received in the form of a touch screen input on the touch screen. In response to receiving the touch screen input, at 1350 and 1360, process 1300 matches the received touch screen input to a first touch screen input type or to a second touch screen input type. At 1350, the process determines whether the touch screen input is a first touch screen input type. When the touch screen input is a first touch screen input type then the first information is presented at 1370. When the touch screen input is a second touch screen input type, then the second information is presented at 1380.

In some implementations, additional information, in addition to the first information and the second information, can each have a corresponding touch screen input type and can correspond to the portion of text. The process 1300 can also determine whether the touch screen input matches one of the additional touch screen input types. If so, the process can present the information corresponding to the matching touch screen input type.

Presenting the first information 1370 can include presenting an audible reading of the portion of the augmented text as the touch screen input is received. For example, when the touch screen input is a swipe and the portion of the augmented text is a word, and an audible pronunciation of a sound for each letter of the word can be produced as the swipe passes over each respective letter of the word.

Presenting the second information 1380 can include presenting media content corresponding to the meaning of the portion of the augmented text. The media content can include an interactive module. For example, when a user touches the augmented portion of the text, an interactive module can be displayed superimposed over the augmented text. The user can use the touch screen user interface to interact with the interactive module. In some examples, the second touch screen input can invoke a presentation of an illustration or an animation related to the meaning of the augmented portion of the text. Also, when a user interacts with the augmented portion of the text, additional information, such as a user-selectable link for navigating to more information, translation data, or other data related to the content of the portion of the augmented text can be displayed.

### Example Device Architecture

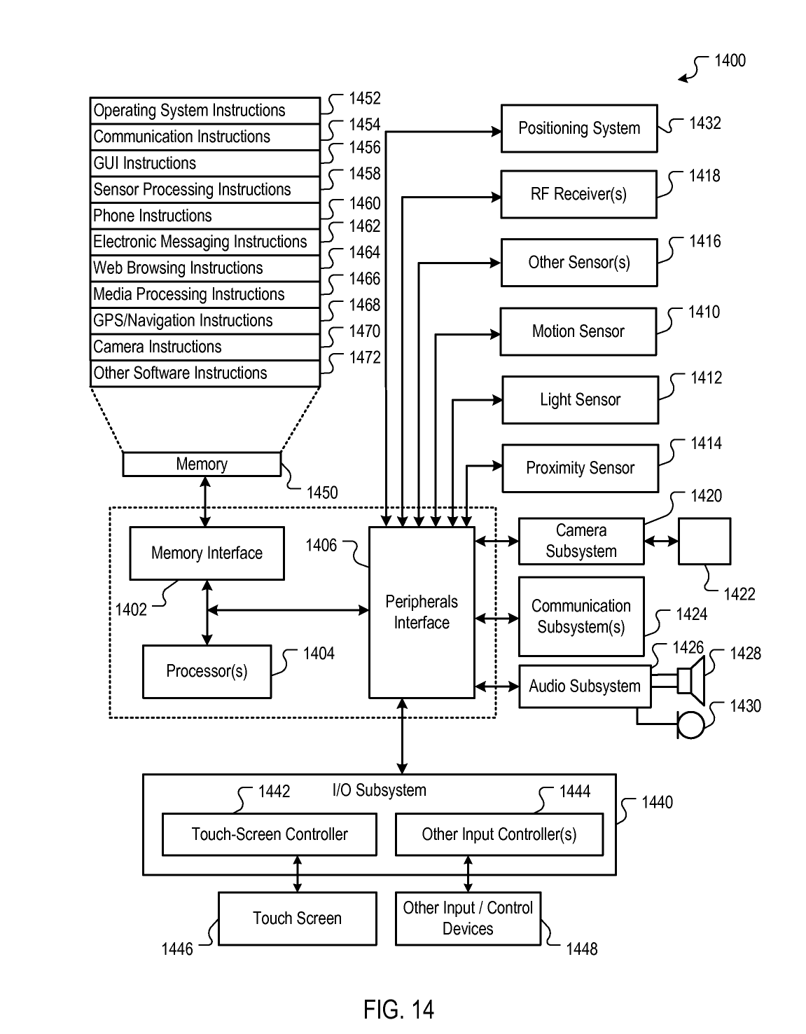

FIG. 14 is a block diagram of an example architecture 1400 for a device for presenting augmented text with which a user can interact. Device 1400 can include memory interface 1402, one or more data processors, image processors and/or central processing units 1404, and peripherals interface 1406. Memory interface 1402, one or more processors 1404 and/or peripherals interface 1406 can be separate components or can be integrated in one or more integrated circuits. The various components in device 1400 can be coupled by one or more communication buses or signal lines.

Sensors, devices, and subsystems can be coupled to peripherals interface 1406 to facilitate multiple functionalities. For example, motion sensor 1410, light sensor 1412, and proximity sensor 1414 can be coupled to the peripherals interface 1406 to facilitate various orientation, lighting, and proximity functions. For example, in some implementations, light sensor 1412 can be utilized to facilitate adjusting the brightness of touch screen 1446. In some implementations, motion sensor 1411 (e.g., an accelerometer, velicometer, or gyroscope) can be utilized to detect movement of the device. Accordingly, display objects and/or media can be presented according to a detected orientation, e.g., portrait or landscape.

Other sensors 1416 can also be connected to peripherals interface 1406, such as a temperature sensor, a biometric sensor, a gyroscope, or other sensing device, to facilitate related functionalities.

Location determination functionality can be facilitated through positioning information from positioning system 1432. Positioning system 1432, in various implementations, can be a component internal to the device 1400, or can be an external component coupled to device 1400 (e.g., using a wired connection or a wireless connection). In some implementations, positioning system 1432 can include a GPS receiver and a positioning engine operable to derive positioning information from received GPS satellite signals. In other implementations, positioning system 1432 can include a compass (e.g., a magnetic compass) and an accelerometer, as well as a positioning engine operable to derive positioning information based on dead reckoning techniques. In still further implementations, positioning system 1432 can use wireless signals (e.g., cellular signals, IEEE 802.11 signals) to determine location information associated with the device. Hybrid positioning systems using a combination of satellite and television signals, such as those provided by ROSUM CORPORATION of Mountain View, Calif., can also be used. Other positioning systems are possible.

Broadcast reception functions can be facilitated through one or more radio frequency (RF) receiver(s) 1418. An RF receiver can receive, for example, AM/FM broadcasts or satellite broadcasts (e.g., XM® or Sirius® radio broadcast). An RF receiver can also be a TV tuner. In some implementations, the RF receiver 1418 is built into the wireless communication subsystems 1424. In other implementations, RF receiver 1418 is an independent subsystem coupled to device 1400 (e.g., using a wired connection or a wireless connection). RF receiver 1418 can receive simulcasts. In some implementations, RF receiver 1418 can include a Radio Data System (RDS) processor, which can process broadcast content and simulcast data (e.g., RDS data). In some implementations, RF receiver 1418 can be digitally tuned to receive broadcasts at various frequencies. In addition, RF receiver 1418 can include a scanning function which tunes up or down and pauses at a next frequency where broadcast content is available.

Camera subsystem 1420 and optical sensor 1422, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 1424. Communication subsystem(s) can include one or more wireless communication subsystems and one or more wired communication subsystems. Wireless communication subsystems can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving and/or transmitting data. The specific design and implementation of communication subsystem 1424 can depend on the communication network(s) or medium(s) over which device 1400 is intended to operate. For example, device 1400 may include wireless communication subsystems designed to operate over a global system for mobile communications (GSM) network, a GPRS network, an enhanced data GSM environment (EDGE) network, 802.x communication networks (e.g., Wi-Fi, WiMax, or 3G networks), code division multiple access (CDMA) networks, and a Bluetooth™ network. Communication subsystems 1424 may include hosting protocols such that device 1400 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 1426 can be coupled to speaker 1428 and one or more microphones 1430. One or more microphones 1130 can be used, for example, to facilitate voice-enabled functions, such as voice recognition, voice replication, digital recording, and telephony functions.

I/O subsystem 1440 can include touch screen controller 1442 and/or other input controller(s) 1444. Touch-screen controller 1442 can be coupled to a touch screen 1446. Touch screen 1446 and touch screen controller 1442 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 1446 or proximity to touch screen 1446.

Other input controller(s) 1444 can be coupled to other input/control devices 1448, such as one or more buttons, rocker switches, thumb-wheel, infrared port, USB port, and/or a pointer device such as a stylus. The one or more buttons (not shown) can include an up/down button for volume control of speaker 1428 and/or microphone 1430.

In one implementation, a pressing of the button for a first duration may disengage a lock of touch screen 1446; and a pressing of the button for a second duration that is longer than the first duration may turn power to device 1400 on or off. The user may be able to customize a functionality of one or more of the buttons. Touch screen 1446 can, for example, also be used to implement virtual or soft buttons and/or a keyboard.

In some implementations, device 1400 can present recorded audio and/or video files, such as MP3, AAC, and MPEG files. In some implementations, the device 1400 can include the functionality of an MP3 player, such as an iPhone™.

Memory interface 1402 can be coupled to memory 1450. Memory 1450 can include high-speed random access memory and/or non-volatile memory, such as one or more magnetic disk storage devices, one or more optical storage devices, and/or flash memory (e.g., NAND, NOR). Memory 1450 can store operating system 1452, such as Darwin, RTXC, LINUX, UNIX, OS X, WINDOWS, or an embedded operating system such as VxWorks. Operating system 1452 may include instructions for handling basic system services and for performing hardware dependent tasks. In some implementations, the operating system 1452 can be a kernel (e.g., UNIX kernel).

Memory 1450 may also store communication instructions 1454 to facilitate communicating with one or more additional devices, one or more computers and/or one or more servers. Communication instructions 1454 can also be used to select an operational mode or communication medium for use by the device, based on a geographic location (obtained by GPS/Navigation instructions 1468) of the device. Memory 1450 may include graphical user interface instructions 1456 to facilitate graphic user interface processing; sensor processing instructions 1458 to facilitate sensor-related processing and functions; phone instructions 1460 to facilitate phone-related processes and functions; electronic messaging instructions 1462 to facilitate electronic-messaging related processes and functions; web browsing instructions 1464 to facilitate web browsing-related processes and functions; media processing instructions 1466 to facilitate media processing-related processes and functions; GPS/Navigation instructions 1468 to facilitate GPS and navigation-related processes and instructions, e.g., mapping a target location; camera instructions 1470 to facilitate camera-related processes and functions; and/or other software instructions 1472 to facilitate other processes and functions, e.g., security processes and functions, device customization processes and functions (based on predetermined user preferences), and other software functions. Memory 1450 may also store other software instructions (not shown), such as web video instructions to facilitate web video-related processes and functions; and/or web shopping instructions to facilitate web shopping-related processes and functions. In some implementations, media processing instructions 1466 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. Memory 1450 can include additional instructions or fewer instructions. Furthermore, various functions of device 1400 may be implemented in hardware and/or in software, including in one or more signal processing and/or application specific integrated circuits.

### Network Operating Environment for a Device

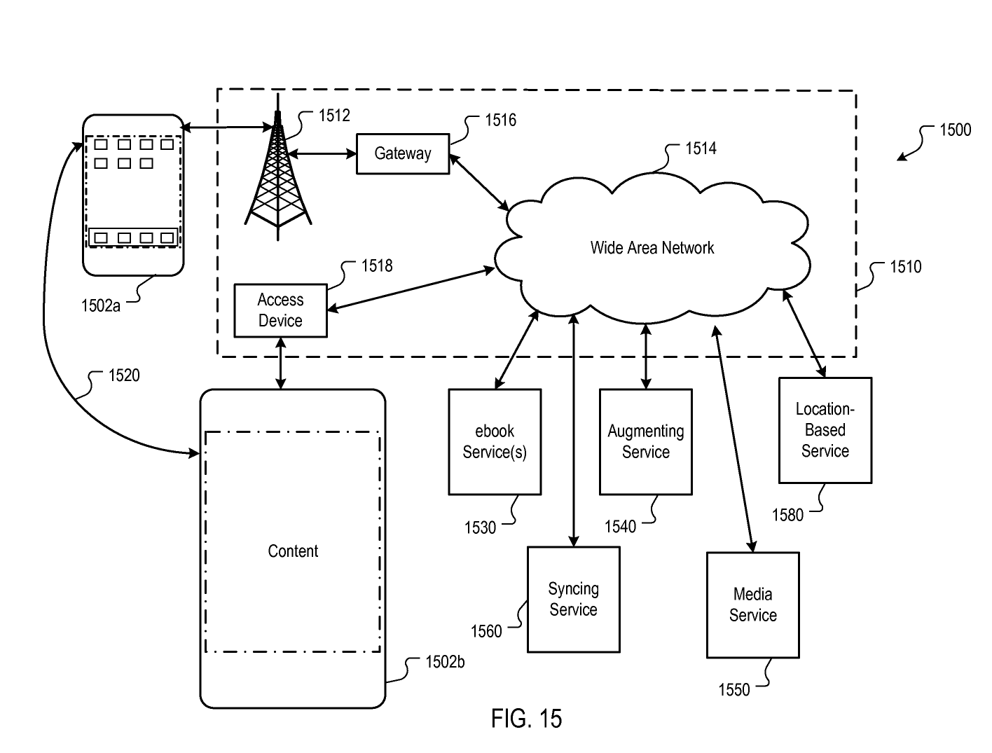

FIG. 15 is a block diagram of example network operating environment 1500 for a device. Devices 1502a and 1502b can, for example, communicate over one or more wired and/or wireless networks 1510 in data communication. For example, wireless network 1512, e.g., a cellular network, can communicate with wide area network (WAN) 1514, such as the Internet, by use of gateway 1516. Likewise, access device 1518, such as an 802.11g wireless access device, can provide communication access to the wide area network 1514. In some implementations, both voice and data communications can be established over wireless network 1512 and access device 1518. For example, device 1502a can place and receive phone calls (e.g., using VoIP protocols), send and receive e-mail messages (e.g., using POP3 protocol), and retrieve electronic documents and/or streams, such as web pages, photographs, and videos, over wireless network 1512, gateway 1516, and wide area network 1514 (e.g., using TCP/IP or UDP protocols). Likewise, in some implementations, device 1502b can place and receive phone calls, send and receive e-mail messages, and retrieve electronic documents over access device 1518 and wide area network 1514. In some implementations, devices 1502a or 1502b can be physically connected to access device 1518 using one or more cables and the access device 1518 can be a personal computer. In this configuration, device 1502a or 1502b can be referred to as a “tethered” device.

Devices 1502a and 1502b can also establish communications by other means. For example, wireless device 1502a can communicate with other wireless devices, e.g., other devices 1502a or 1502b, cell phones, etc., over wireless network 1512. Likewise, devices 1502a and 1502b can establish peer-to-peer communications 1520, e.g., a personal area network, by use of one or more communication subsystems, such as a Bluetooth™ communication device. Other communication protocols and topologies can also be implemented.

Devices 1502a or 1502b can, for example, communicate with one or more services over one or more wired and/or wireless networks 1510. These services can include, for example, an electronic book service 1530 for accessing, purchasing, and/or downloading ebook files to the devices 1502a and/or 1502b. An ebook can include augmenting information that augments the text of the ebook.

In some examples, augmenting information can be provided as a separate file. The user can download the separate file from the electronic ebook service 1530 or from an augmenting service 1540 over the network 1510. In some examples, the augmenting service 1540 can analyze text stored on a device 1502a and or 1502b and determine augmenting information for the text such as for text of an ebook. The augmenting information can be stored in an augmenting file for an existing ebook loaded onto devices 1502a and/or 1502b.

An augmenting file can include augmenting information for display when a user interacts with text in the ebook. In some examples, the augmenting file can include commands for downloading augmenting data from the augmenting service or from some other website over network 1510. For example, when such a command is invoked, e.g. by user interaction with the text of the ebook, augmenting service 1540 can provide augmenting information for an ebook loaded onto device 1502a and or 1502b. Also, an interactive module displayed in response to a touch screen input can require additional data from various services over network 1510, such as data from location-based service 1580, from a gaming service, from and application and/or widget service etc. In some examples, a touch screen input can interact with text in an ebook to invoke a command to obtain updated news information from media service 1550.

Augmenting service 1540 can also provide updated augmenting data to be loaded onto an augmenting file stored on a device 1502a and/or 1502b via a syncing service 1560. The syncing service 1560 stores the updated augmenting information until a user syncs the devices 1502a and/or 1502b. When the devices 1502a and/or 1502b are synced, the augmenting information for ebooks stored on devices is updated.

The device 1502a or 1502b can also access other data and content over the one or more wired and/or wireless networks 1510. For example, content publishers, such as news sites, RSS feeds, web sites, blogs, social networking sites, developer networks, etc., can be accessed by the device 1502a or 1502b. Such access can be provided by invocation of a web browsing function or application (e.g., a browser) in response to a user touching, for example, text in an ebook or touching a Web object.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, many of the examples presented in this document were presented in the context of an ebook. The systems and techniques presented herein are also applicable to other electronic text such as electronic newspaper, electronic magazine, electronic documents etc. Also, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer readable medium encoded with a computer program, the program comprising instructions that when executed by a data processing apparatus cause the data processing apparatus to perform operations comprising:
presenting augmented text from an electronic book in a user-interface displayed in a touch screen;
receiving touch screen input by the touch screen, the touch screen input corresponding to a portion of the augmented text;
determining a command associated with the touch screen input from amongst multiple commands associated with the portion of the augmented text, each of the multiple commands being configured to invoke a different function to present information regarding the portion of the augmented text; and
presenting, based on the command associated with the received touch screen input, information corresponding to the identified portion of the augmented text.

2. The computer readable medium of claim 1,
wherein presenting information comprises presenting the information superimposed over the augmented text for a predetermined time period.

3. The computer readable medium of claim 1, further comprising:
receiving an audio input corresponding to the portion of the augmented text; and
wherein the presenting information corresponding to the identified portion of the augmented text further comprises presenting the information based also on a command corresponding to the audio input.

4. The computer readable medium of claim 1, wherein:
the portion of the augmented text comprises a word;
the touch screen input comprises a finger swipe over a region corresponding to a beginning letter in the word to an ending letter in the word; and
presenting information further comprises producing an audible reading of the word.

5. The computer readable medium of claim 3, wherein producing the audible reading of the word comprises producing the audible reading based on a speed of the swipe.

6. The computer readable medium of claim 3, wherein producing an audible reading of the word comprises, for each letter of the word, producing an audible pronunciation of a sound corresponding to the letter as the swipe passes over the letter.

7. The computer readable medium of claim 3, wherein the region is below the word.

8. The computer readable medium of claim 1, wherein:
the portion of the augmented text comprises a series of words; and
presenting information further comprises producing an audible reading of the series of words.

9. The computer implemented method of claim 1, wherein:
the portion of the augmented text comprises a noun; and
presenting information comprises displaying an illustration of the noun superimposed over the augmented text.

10. The computer implemented method of claim 1, wherein
the portion of the augmented text comprises a verb; and
presenting information comprises displaying an animation superimposed over the augmented text, the animation performing the verb.

11. The computer implemented method of claim 10, wherein the animation comprises the portion of the augmented text performing the verb.

12. The computer readable medium of claim 1, wherein presenting the information comprises presenting, superimposed over the augmented text, an interactive module corresponding to the portion of the augmented text for a predetermined time period.

13. The computer readable medium of claim 12, wherein the interactive module comprises a game.

14. The computer readable medium of claim 1, wherein:
the portion of the augmented text comprises a phrase; and
wherein presenting information regarding the portion of the augmented text comprises displaying information regarding the meaning of the phrase.

15. The computer readable medium of claim 14, wherein the touch-screen input comprises a finger placed over a first region corresponding to a beginning word in the phrase and another finger placed over second region corresponding to a last word in the phrase.

16. The computer readable medium of claim 1, wherein the program comprises further instructions that when executed by the data processing apparatus cause the data processing apparatus to perform operations further comprising:
receiving a request to augment an ebook file comprising the text for the ebook; and
augmenting various portions of the text with multiple types of information, each having a corresponding touch screen input.

17. A computer readable medium encoded with a computer program, the program comprising instructions that when executed by a data processing apparatus cause the data processing apparatus to perform operations comprising:
presenting text from an electronic book in a user-interface, the user-interface displayed in a touch screen;
receiving a first touch screen input of a first type via the touch screen, the first touch screen input corresponding to a portion of the text;
presenting, based on the first type, first information corresponding to the portion of the text;
receiving a second touch screen input of a second type on the touch screen, the second touch screen input corresponding to the portion of the text, wherein the second type differs from the first type; and
presenting, based on the second type, second information corresponding to the identified portion of the text.

18. The computer readable medium of claim 17, wherein
presenting first information comprises presenting an audible reading of the portion of the text; and
presenting second information comprises presenting a display of media content corresponding to the meaning of the portion of the text.

19. The computer readable medium of claim 18, wherein
the portion of the text comprises a word; and
the first touch screen input comprises a gesture over a region corresponding to the word.

20. The computer readable medium of claim 18, wherein the media content comprises a still image.

21. The computer readable medium of claim 18, wherein the media content comprises interactive content.

22. The computer readable medium of claim 18, wherein the media content comprises an animation.

23. The computer readable medium of claim 18, wherein
the portion of the text comprises a word; and
presenting an audible reading of the portion of the text comprises presenting a pronunciation of the word as the first touch screen input is received at a pronunciation speed corresponding to a speed of the first touch screen input.

24. The computer readable medium of claim 18, wherein the program comprises further instructions that when executed by the data processing apparatus cause the data processing apparatus to perform operations further comprising:
receiving user-input in the form of a shake of the touch screen; and
in response to receiving the user-input, removing the display of the media content.

25. The computer readable medium of claim 17, wherein
the portion of the text comprises a phrase;
the first touch screen input comprise a gesture over a region corresponding to the phrase;
presenting first information comprises presenting an audible reading of the phrase;
the second touch screen input comprises a touch input over a beginning word in the phrase and a simultaneous touch input over a last word in the phrase; and
presenting second information comprises presenting a display having media content corresponding to the meaning of the phrase.

26. The computer readable medium of claim 17, wherein
presenting first information comprises displaying a translation of the portion of the text into a different language; and
presenting second information comprises presenting an audible pronunciation of a translated portion of the text into the different language.

27. A machine implemented method comprising:
presenting augmented text in a user-interface that is displayed on a touch screen;
storing, for a portion of the augmented text, first information corresponding to a first touch screen input type and second information corresponding to the second touch screen input type, the first information and the second information relating to content associated with the portion of the augmented text;
receiving user input in the form of a touch screen input;
invoking a display of content regarding the portion of the augmented text based on a type of the touch screen input and a proximity of the touch screen input to the portion of the augmented text; and
wherein invoking a display of content regarding the portion of the augmented text comprises:
presenting the first information when the type of touch screen input matches the first touch screen input type, and
presenting the second information when the type of touch screen input matches the second touch screen input type.

28. The method of claim 27, wherein presenting the first information comprises presenting an audible reading of the portion of the augmented text as the touch screen input is received.

29. The method of claim 28, wherein
the portion of the augmented text comprises a word;
the touch screen input comprises a gesture; and
producing an audible reading of the portion of the augmented text comprises producing an audible pronunciation of a sound for each letter of the word as the gesture passes over a region corresponding to each respective letter of the word.

30. The method of claim 27, wherein presenting the second information comprises presenting media content corresponding to the meaning of the portion of the augmented text.

31. The method of claim 30, wherein the media content comprises an interactive module.

32. The method of claim 30, wherein the media content comprises an animation depicting an action described in the portion of the augmented text.

33. The method of claim 30, wherein the first information includes a link for additional information regarding content of the portion of the augmented text.

34. A system comprising:
a memory device for storing electronic book data;
a computing system including processor electronics configured to perform operations comprising:
presenting augmented text from the electronic book in a user-interface, the user-interface displayed in a touch screen;
receiving a first touch screen input of a first type via the touch screen, the first touch screen input corresponding to a portion of the augmented text;
presenting, based on the first type, first information corresponding to the portion of the augmented text;
receiving a second touch screen input of a second type via the touch screen, the section touch screen input corresponding to the portion of the augmented text, wherein the second type differs from the first type; and
presenting, based on the second type, second information corresponding to the invoked portion of the augmented text.

35. The system of claim 34, wherein:
presenting first information comprises presenting an audible reading of the portion of the augmented text; and
presenting second information comprises presenting a display of media content corresponding to the meaning of the portion of the augmented text.

36. The system of claim 35, wherein:
the portion of the augmented text comprises a word;
the first touch screen input comprises a swipe over a region corresponding the word; and
presenting an audible reading of the word comprises presenting an audible pronunciation of each letter of the word as the swipe passes over a region corresponding to each respective letter of the word.

37. The system of claim 36, wherein the processor electronics are further configured to perform operations comprising:
displaying an indicator of a letter of the word being pronounced.

38. The system of claim 35, wherein the media content comprises an animation.

39. The system of claim 35, wherein the media content comprises an interactive module.
